(19) United States
(12) Patent Application Publication
(10) Pub. No.: US 2004/0009305 A1
(43) Pub. Date: Jan. 15, 2004

(54) Process for preparing graft copolymer membranes

(75) Inventors: Charles Stone, West Vancouver (CA); Lukas M. Bonorand, Coquitlam (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby (CA)

(21) Appl. No.: 10/229,381

(22) Filed: Aug. 27, 2002

Related U.S. Application Data
(60) Provisional application No. 60/395,517, filed on Jul. 12, 2002.

(51) Int. Cl. B05D 3/00

(52) U.S. Cl. 427/551; 427/553; 427/248.1

(57) ABSTRACT

A process for preparing a graft copolymer membrane is provided comprising exposing a porous polymeric base film to a dose of ionizing radiation, and then contacting the irradiated base film with an emulsion comprising a fluorostyrenic or fluoronaphthyl monomer. The graft copolymer membrane may be densified to render it substantially gas-impermeable.

### CROSS-REFERENCE TO RELATED APPLICATIONS

This application claims the benefit of U.S. Provisional Application No. [not yet assigned, converted from U.S. application Ser. No. 09/940,690 by petition dated Jul. 15, 2002] and U.S. Provisional Patent Application No. 60/395,517 filed Jul. 12, 2002, both of which provisional applications are incorporated herein by reference in its entirety.

### BACKGROUND OF THE INVENTION

1. Field of the Invention

The present invention relates to processes for preparing graft copolymer membranes by radiation induced graft polymerization of fluorostyrenic monomers, employing porous polymeric base films.

2. Description of the Related Art

The preparation of graft polymeric membranes by radiation induced graft polymerization of a monomer to a polymeric base film has been demonstrated for various combinations of monomers and base films. The grafting of styrene to a polymeric base film, and subsequent sulfonation of the grafted polystyrene chains has been used to prepare ion-exchange membranes.

U.S. Pat. No. 4,012,303 reports the radiation induced graft polymerization of α,β,β-trifluorostyrene (TFS) to dense polymeric base films using gamma ray co-irradiation. The graft polymerization procedure may use TFS in bulk or in solution. The '303 patent reports that aromatic compounds or halogenated compounds are suitable solvents.

U.S. Pat. No. 4,605,685 reports the graft polymerization of TFS to pre-irradiated polymeric base films. Dense polymeric base films, such as for example polyethylene and polytetrafluoroethylene, are pre-irradiated and then contacted with TFS neat or dissolved in a solvent. The '685 patent also states that the base films may have fine pores.

U.S. Pat. No. 6,225,368 reports graft polymerization of unsaturated monomers to pre-irradiated polymeric base films employing an emulsion including the monomer, and emulsifier and water. In the method of the '368 patent, a base polymer is activated by irradiation, quenched so as to affect cross-linking of the polymer, and then activated again by irradiation. The activated, cross-linked polymer is then contacted with the emulsion. Graft polymerization to dense polymeric base films is reported, although the '368 patent mentions that microporous base films may also be employed. The '368 patent also states that the use of the disclosed method eliminates homopolymerization caused by irradiation of the monomer, and that this allows the use of high concentrations of monomers in the emulsion.

These methods of preparing graft polymeric membranes have several disadvantages.

With co-irradiation, since the TFS monomer is simultaneously irradiated, undesirable processes such as monomer dimerization and/or independent homopolymerization of the monomer may occur in competition with the desired graft polymerization reaction.

When neat TFS is employed in graft polymerization reactions, it can be difficult to achieve a contact time between the monomer and a dense irradiated base film resulting in the desired level of graft polymerization that would be suitable for high-volume production. Typically, the neat monomer does not wet the surface of the base film very effectively, and this can result in an undesirably low graft polymerization rate unless a prolonged contact time is employed. Further, the use of neat TFS may adversely increase the cost of the graft polymerization process, due to the excess of monomer that is required.

A disadvantage of graft polymerization reactions carried out using TFS solutions is the level of graft polymerization drops significantly as the concentration of monomer in the solution is lowered. Indeed, the '303 patent reports a significant decrease in percentage graft with decreasing TFS concentrations. The drop in percentage graft may be mitigated by increasing the radiation dosage and/or the grafting reaction temperature, but this necessarily increases the energy requirements of the graft polymerization process and may promote undesirable side reactions. Overall, the use of TFS in solution tends to undesirably increase the cost of the graft polymerization process.

Cross-linking the base polymer by irradiating and quenching it prior to grafting necessitates two separate irradiation steps. Quenching further involves heating the irradiated polymer and/or the addition of cross-linking agents. An obvious disadvantage to this process is that these steps add time and expense to the process and complicate the overall preparation of the graft polymeric membranes. Further, for many applications, the cross-linking of the base film is not desirable.

In general, radiation-induced graft polymerization employing dense base films is a diffusion-controlled process that proceeds according to a grafting front mechanism. Monomers must diffuse through an already grafted layer to access available free radicals in order to initiate further graft polymerization. At the same time, recombination of free radicals can occur, making them unavailable for graft polymerization reactions. As a result, radiation-induced graft polymerization employing dense base films can have several disadvantages.

For example, the resulting graft copolymer membrane may have a heterogeneous distribution of grafted polymer chains through its volume, and may also have grafted polymer chains of varying molecular weights. These structural effects may adversely affect the functionality of the end product in a given application. Also, the process is time consuming because the reaction rate is dependent on the surface area per unit volume of the dense base film. Furthermore, the dense base film is constantly supplied with monomer (typically heated) during the grafting reaction and side reactions can result in significant monomer and an effective reduction in monomer concentration. This can adversely impact the cost of making the graft copolymer membranes, as the monomer can be a major cost component.

### BRIEF SUMMARY OF THE INVENTION

A process for preparing a graft copolymer membrane is provided comprising exposing a porous polymeric base film to a dose of ionizing radiation, and then contacting the irradiated base film with a fluorostyrenic monomer.

In one embodiment, the present process for preparing a graft copolymer membrane comprises: exposing a porous polymeric base film to a dose of ionizing radiation; contacting the irradiated base film with at least one fluorostyrenic monomer to form a graft copolymer; and then collapsing the porosity of the graft copolymer membrane.

In another embodiment, the present process for preparing a graft copolymer membrane comprises: exposing a porous polymeric base film to a dose of ionizing radiation; and contacting the irradiated base film with an emulsion comprising at least one fluorostyrenic monomer, where the amount of monomer in the emulsion is less than or equal to 30% by volume.

In another embodiment, the present process for preparing a graft copolymer membrane comprises: exposing a continuous web comprising a porous polymeric base film to a dose of ionizing radiation; impregnating the irradiated base film with at least one fluorostyrenic monomer at a first temperature; and exposing the irradiated base film and impregnated monomer to a second temperature higher than the first temperature to form a graft copolymer.

### BRIEF DESCRIPTION OF THE DRAWING

FIG. 1 is a schematic representation of an embodiment of the present process.

### DETAILED DESCRIPTION OF THE INVENTION

In the present process, a graft copolymer membrane is prepared by exposing a porous polymeric base film to a dose of ionizing radiation, and then contacting the irradiated base film with a fluorostyrenic monomer. Any radiation capable of introducing sufficient concentrations of free radical sites on and within the polymeric base film may be used in the preparation of the graft copolymer membranes described herein. For example, the irradiation may be by gamma rays, X-rays, electron beam, high-energy UV radiation, or any combination thereof. The base film is irradiated in an inert atmosphere. The radiation dose to which the base film is exposed may vary from 1-100 Mrad. Typically, the dose range is between 20-60 Mrad.

Typically, the base film imparts mechanical strength to the membrane and should be physically and chemically stable to irradiation and the conditions to which it is to be exposed in the end-use application of the graft copolymer membrane. Suitable base films include homopolymers or copolymers of non-fluorinated, fluorinated and perfluorinated vinyl monomers. Fluorinated and perfluorinated polymers may be desired for certain applications due to their enhanced oxidative and thermal stability. Suitable base films include, but are not limited to, films comprising polyethylene, polypropylene, polyvinylidene fluoride, polytetrafluoroethylene, poly(ethylene-co-tetrafluoroethylene), poly(tetrafluoroethylene-co-perfluorovinylether), poly(tetrafluoroethylene-co-hexafluoropropylene), poly(vinylidene fluoride-co-hexafluoropropylene), poly(vinylidene fluoride-co-chlorotrifluoroethylene), and poly(ethylene-co-chlorotrifluoroethylene).

The structure of the porous base film is not essential to the present process. Non-limiting examples of suitable structures include non-woven, microporous, woven, expanded, perforated, and foam base films.

The irradiated base film is then contacted with the monomer(s), which is then incorporated into the base film to form a graft copolymer. The irradiated base film may be contacted with the monomer(s) in an inert atmosphere, if desired.

Suitable fluorostyrenic monomers include α-fluorostyrenes, α,β-difluorostyrenes, α,β,β-trifluorostyrenes, and the corresponding fluoronaphthylenes. Unsubstituted and substituted monomers, particularly para-substituted monomers, may be employed. Mixtures of fluorostyrenic monomers may also be employed in the emulsion, if desired.

As used herein and in the appended claims, a substituted fluorostyrenic monomer refers to monomers having substituents on the aromatic ring. Suitable substituted α,β,β-trifluorostyrenes and α,β,β-trifluoronaphthylenes are described in PCT Application No. PCT/CA98/01041, and PCT Application No. PCT/CA00/00337. Examples of such α,β,β-trifluorostyrenes include, but are not limited to, methyl-α,β,β-trifluorostyrene, methoxy-α,β,β-trifluorostyrene, thiomethyl-α,β,β-trifluorostyrene, and phenyl-α,β,β-trifluorostyrene.

Other suitable non-fluorinated monomers, such as styrene, α-methylstyrene, and vinyl phosphonic acid, for example, may also be employed. Depending on the end-use application of the graft copolymer membrane, the incorporation of a proportion of such non-fluorinated monomers may reduce the cost of the membrane without unduly affecting performance.

The irradiated base film may be contacted with the monomer(s) as a neat liquid or as a monomer solution. The monomer solution solvent may be selected so as to facilitate swelling of the base film.

Alternatively, the irradiated base film may be contacted with an emulsion of the monomer(s). The emulsion may be an aqueous system, i.e., an emulsion comprising the monomer(s) and water. Alternatively, a non-aqueous emulsion may be employed, comprising the monomer(s) and an immiscible solvent. The solvent may be selected so as to facilitate swelling of the base film. As a further alternative, an aqueous emulsion may be used that also includes a solvent that facilitates swelling of the base film.

The emulsion may further comprise an emulsifier. Ionic and nonionic emulsifiers may be employed. Non-limiting examples of suitable emulsifiers include sodium lauryl sulfate and dodecylamine hydrochloride. Depending upon the type and concentration of monomer(s) employed in the emulsion, an emulsifier may increase the stability of the emulsion. The particular emulsifier, if it is employed, is not essential and persons skilled in the art can readily choose a suitable emulsifier for a given application.

If desired, the neat monomer, monomer solution or emulsion may also comprise an inhibitor to limit the amount of dimerization and/or homopolymerization of the monomer(s) that may occur during graft polymerization. Again, the choice of inhibitor is not essential to the present process and suitable inhibitors will be apparent to persons skilled in the art.

The graft polymerization reaction may be carried out at any suitable temperature. Higher temperatures may result in higher graft polymerization rates, but can also increase the rate of dimerization/homopolymerization of the monomer. Suitable temperature ranges will depend on such factors as the desired level of grafting of the base film, the graft polymerization rate as a function of temperature for the monomer(s) employed, and the rate of dimerization/homopolymerization of the monomer(s) as a function of temperature. For example, temperatures in the range of 20-100° C. are suitable, with a range of 50-80° C. being typical when employing α,β,β-trifluorostyrenic monomers. Persons skilled in the art can readily determine suitable temperature ranges for a given application of the present process.

The method by which the irradiated base film is contacted with the monomer is not essential to the present process. For example, the irradiated base film may be soaked or dipped in a monomer bath, or the monomer could be coated as a layer onto the irradiated base film. Alternatively, the monomer could be sprayed on; where an monomer emulsion is employed, the emulsion could be sprayed on as a prepared emulsion or as components that form the emulsion in situ. As a further example, the monomer could be contacted with the irradiated base film as a mist. A combination of any of the foregoing methods may also be employed.

After graft polymerization, the graft copolymer membrane may be washed in a suitable solvent. The choice of solvent is not essential to the present process. Generally, it should be a solvent for the monomer but not for the base film. Persons skilled in the art can readily determine suitable solvents for a particular application.

Ion exchange functionality may then be introduced (directly or indirectly) into the graft copolymer membrane by subsequent reactions, such as, halomethylation, sulfonation, phosphonation, amination, carboxylation, hydroxylation and nitration, for example, to produce an ion exchange membrane suitable for various applications. More than one ion exchange moiety may be introduced into the graft copolymer membrane, if desired. Sulfonation and/or phosphonation, in particular, may be employed where the graft copolymer membrane is intended as an ion exchange membrane for use in fuel cell applications.

The particular method of introducing ion exchange functionality into the graft copolymer membrane is not essential to the present process, nor is the selection of the particular reagent. For example, where a sulfonated graft copolymer membrane is desired, liquid or vapor phase sulfonation may be employed, using sulfonating agents such as sulfur trioxide, chlorosulfonic acid (neat or in solution), and oleum; with chlorosulfonic acid a subsequent hydrolysis step may be required.

The graft copolymer membrane may be presoaked with a solvent before sulfonation, if desired. The solvent should be compatible with the sulfonating agent and may contain acetic acid to reduce sulfone formation. The solvent may also swell the graft copolymer membrane, thereby opening up its structure and facilitating access to the interior of the graft copolymer membrane by the sulfonating agent. Suitable solvents include halogenated solvents such as 1,2-dichloroethane and 1,1,2,2-tetrachloroethane, for example.

The present process may further comprise densifying the graft copolymer membrane to produce a substantially gas-impermeable membrane. For example, the graft copolymer membrane may be densified by impregnating it to substantially fill the porosity or by collapsing the porosity of the graft copolymer membrane. In the latter instance, the porosity may be collapsed by the application of pressure and heat. For example, the graft copolymer membrane could be heated to at least the melt flow temperature of the base film. In some applications, it may be desirable to select a base film having a lower melt flow temperature than the grafted side-chains. Alternatively, depending on the selection of fluorostyrenic monomer(s) and base film, it may be possible to collapse the porosity of the graft copolymer membrane by the application of pressure at ambient temperature. Other methods of densifying the graft copolymer membrane may also be employed, as will be apparent to persons skilled in the art. It is anticipated that this process is applicable to other porous polymeric materials, in addition to the present graft copolymer membrane.

Where an ion exchange membrane is desired, ion exchange functionality can be introduced into the graft copolymer membrane before or after densification.

The use of chlorosulfonic acid to generate an intermediate sulfonyl chloride functionality may facilitate the collapse of porosity in the graft copolymer membrane. The presence of the sulfonyl chloride functionality, and sulfonyl halides in general, tends to decrease the temperature at which irreversible collapse of the porous structure occurs, relative to a sulfonated membrane. Further, issues relating to the thermal stability of the sulfonic acid functionality, such as desulfonation, may be avoided by collapsing the porosity of the graft copolymer membrane in a sulfonyl halide form. In applications where relatively high temperatures are required to collapse the porosity, this approach may be desirable. As mentioned previously, ion exchange functionality can be introduced by subsequently hydrolyzing the sulfonyl halide to yield a sulfonated graft copolymer membrane.

Alternatively, the sulfonated graft copolymer membrane could be converted to a sulfonate salt form. Sulfonate salts are represented by the formula SO₃⁻M⁺, where M⁺ may be any suitable counterion, such as, for example, metal cations and quaternary ammonium ions. The salt form of the membrane typically exhibits superior thermoplastic characteristics, and increased thermal stability, relative to the sulfonic acid form. Again, where relatively high temperatures are required to collapse the porosity of the graft copolymer membrane, this approach may also be desirable.

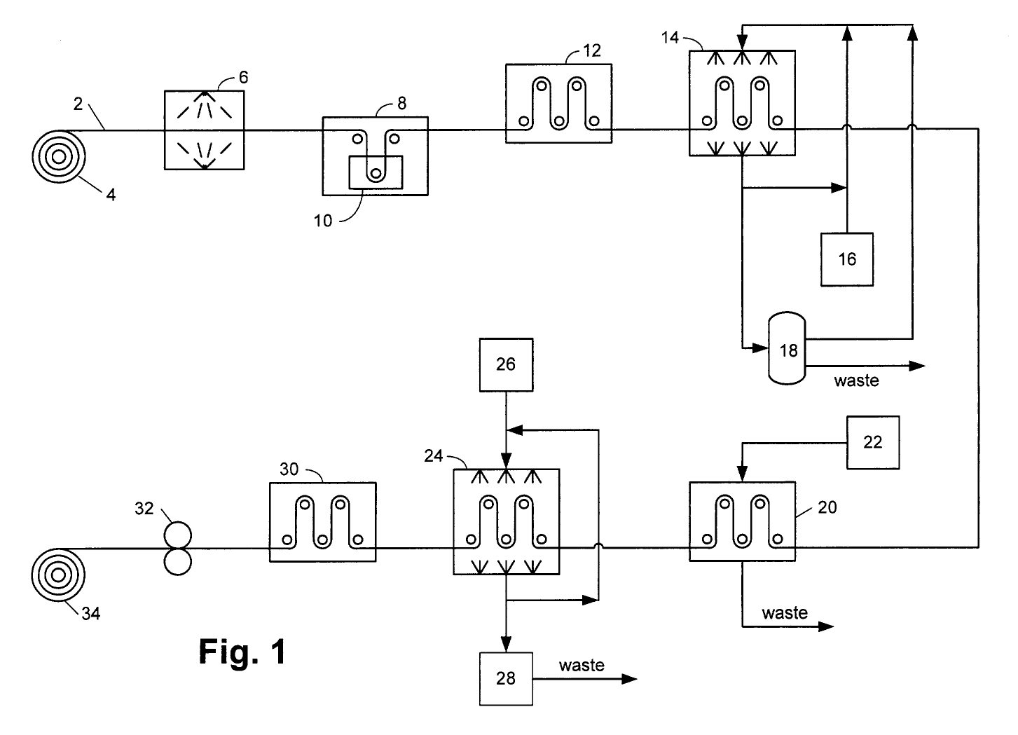

FIG. 1 is a schematic representation of an embodiment of the present process. A porous polymeric base film is fed from roller station 4 to irradiation chamber 6, where it is exposed to a dose of ionizing radiation in an inert atmosphere. The irradiated base film then moves to monomer chamber 8 containing tank 10. A fluorostyrenic monomer, as a neat liquid, a solution or emulsion, impregnates into the pores of irradiated base film as it passes through tank 10.

The degree of impregnation of base film by monomer can be selected to give a desired percentage graft polymerization. In this context, impregnation includes coating the surfaces of the base film as well as filling the interior porosity with the grafting medium.

Impregnation of irradiated base film by the monomer in tank 10 may be facilitated by selecting an appropriate base film and monomer. For example, if substantially hydrophobic monomers are to be used as a neat liquid or in an organic solvent system, the selected base film may be similarly hydrophobic in order to facilitate impregnation of the monomers. Conversely, if a more hydrophilic base film is to be used, then more polar monomers or monomer solutions may be selected, or an emulsion may be employed to aid in wetting the surface of the irradiated base film and impregnation of monomers. Similarly, the line speed can be selected to allow a sufficient dwell time of irradiated base film in tank 10 to ensure adequate impregnation of monomer.

Where a monomer emulsion is employed, tank 10 may also comprise means for agitating the emulsion, if desired. Conventional means for agitating the emulsion include stirring, sparging and ultrasonicating. Agitating may assist in maintaining the homogeneity of the emulsion.

While tank 10 is employed in the illustrated embodiment, it is understood that other means could be used to ensure adequate impregnation of monomer in base film. For example, standard coating or spraying equipment could be employed which may apply a metered amount of monomer to the base film.

The irradiated base film and monomer then moves to grafting chamber 12 where the monomer is incorporated into the irradiated base film to form a graft copolymer membrane. If desired, grafting chamber 12 may be heated to enhance the rate of graft polymerization.

The graft copolymer membrane is then supplied to wash station 14 where it is washed in a suitable solvent. Solvent is provided to wash station 14 from solvent supply 16. Waste material may be separated from the solvent in separator 18 and the solvent recycled, as illustrated.

The graft copolymer membrane is then supplied to sulfonation chamber 20 and sulfonated therein. Sulfur trioxide from supply 22 is supplied to sulfonation chamber as a vapor. If desired, sulfonation chamber 20 may be heated and/or pressurized to enhance the rate of sulfonation. The sulfur trioxide may be diluted with an inert gas, such as nitrogen, to reduce its reactivity, as well. If desired, the graft copolymer membrane could be pre-soaked in a solvent to swell it, thereby facilitating sulfonation of the interior volume. Of course, other sulfonation reagents and/or conditions may be employed in sulfonation chamber 20, as discussed above.

Similarly, sulfonation chamber 20 could be replaced with a chamber for introducing a different ion exchange functionality into the graft copolymer membrane, such as those discussed above.

The sulfonated graft copolymer membrane is then directed to water wash station 26. The wash water is recovered and recycled, and waste is collected in vessel 28 for disposal, as illustrated. The sulfonated graft copolymer membrane is then dried in station 30.

The process of FIG. 1 further comprises a station for densifying the sulfonated graft copolymer membrane to form a substantially gas impermeable membrane. In the illustrated embodiment, heated nip rollers 32 apply heat and pressure to the sulfonated graft copolymer membrane to collapse its porosity. The now substantially gas impermeable membrane is collected at roller station 34. Alternatively, a pair of rollers could be incorporated into drying station 30, if desired. Further, in applications where it is possible to collapse porosity in the sulfonated graft copolymer membrane without heating it, a station for applying pressure could be employed. The particular apparatus used to densify the graft copolymer membrane is not essential to the present process, and persons skilled in the art will recognize other suitable densifying means.

It is anticipated that sulfonating the graft copolymer membrane before densifying may increase the sulfonation rate and homogeneity of sulfonation by increasing the surface area of the film that is contacted by the sulfonating agent. However, the present process also contemplates densifying before sulfonation. Thus, in FIG. 1 a station for collapsing the porosity of the graft copolymer membrane by applying heat and pressure could be placed before or after sulfonation station 24. The same considerations apply when introducing other ion exchange functionality into the graft copolymer membrane.

Where the graft copolymer membrane is to be used as an ion exchange membrane in a fuel cell application, porosity in the graft copolymer membrane could be collapsed during bonding of the membrane to electrodes to form a membrane electrode assembly (MEA). For example, the graft copolymer membrane could be interposed between anode and cathode substrate material and the materials laminated together using heat and pressure to form an MEA, either in a discrete or continuous process.

In some applications, it may be desirable to incorporate additives into the present graft copolymer membrane. Examples of such additives include catalyst particles, anti-oxidants, hydroscopic compounds such as silica or hydrogels, and flexibilizers or plasticizers. The present process may further comprise introducing additives into the porosity of the graft copolymer membrane as, for example, a powder, paste, solution or gel, and then collapsing the porosity. After collapsing the porosity, the additives remain trapped within the structure of the membrane.

For example, hygroscopic compounds can be added to the graft copolymer membrane that may enable operation of fuel cells at temperatures exceeding 100° C. As used herein and in the appended claims, hygroscopic compounds include compounds that can be elaborated into hygroscopic compounds in the graft copolymer membrane. Such compounds should be hydrophilic and have a high boiling point. Examples of suitable materials include hydrogels, low molecular weight dicarboxylic acids or anhydrides, such as maleic anhydrides or styrene maleic anhydrides, and silicates, such as tetraethylorthosilicate.

As another example, additives can be added to increase proton conductivity of the graft copolymer membrane when employed as an ion exchange membrane in fuel cells operating above 100° C., in applications where the availability of water in the cell is limited. Suitable additives include inorganic proton conductors such as zirconium phosphate, cerium phosphate, aluminum phosphate-based zeolites, and polyantimonic acid.

### EXAMPLE 1

### Graft Polymerization of Para-Methyl-α,β,β-Trifluorostyrene (p-ME-TFS) to Porous Poly(Ethylene-Co-Chlorotrifluoroethylene) (Halar®) Film

Two 7 cm×7 cm samples of poly(ethylene-co-chlorotrifluoroethylene) (Halar®) film were prepared from Halar® MBF (porous film; 630 μm thick, 204 g/m²). The samples were irradiated with a dose of 20 Mrad using a 10 MeV ion beam radiation source. Both samples were irradiated in an inert atmosphere with dry ice cooling. A 30% (v/v) emulsion was prepared by adding neat, degassed p-Me-TFS and dodecylamine hydrochloride to water (DDA.HCl; 0.050 g/mL water). Sample 1 was immersed in the emulsion at 60° C. for 24 hours, in an inert atmosphere. Sample 2 was exposed to neat, degassed p-Me-TFS under the same reaction conditions. The p-Me-TFS graft copolymer membranes were then washed twice with acetone and once with toluene before being dried at 45° C. in a vacuum (3.9 kPa) for 3 hours. The percentage graft polymerization for each sample was then determined by calculating the percentage increase in mass of the graft copolymer membrane relative to the mass of the base film.

The reaction conditions and percentage graft polymerization for each sample is summarized in Table 1.

TABLE 1
Graft polymerization of p-Me-TFS to
poly(ethylene-co-chlorotrifluoroethylene) film

| | Dense | Thick- | | | Temper- | |
|---|---|---|---|---|---|---|
| | or | ness | Dose | Emulsion | ature | |
| Sample | Porous | (μm) | (Mrad) | or Neat | (° C.) | % Graft |
| 1 | porous | 630 | 20 | neat | 60 | 49 |
| 2 | porous | 630 | 20 | emulsion | 60 | 69 |

### EXAMPLE 2

### Emulsion Graft Polymerization of p-Me-TFS to Poly(Ethylene-Co-Chlorotrifluoroethylene) (Halar®) Film

7 cm×7 cm samples of poly(ethylene-co-chlorotrifluoroethylene) (Halar®) film were prepared from 25 μm thick Halar® 300LC (dense film) and Halar® MBF (porous film; 630 μm thick, 204 g/m²). The samples were irradiated with a dose of 20 Mrad using a 10 MeV ion beam radiation source, in an inert atmosphere with dry ice cooling. A 30% (v/v) emulsion was prepared by adding neat, degassed p-Me-TFS and sodium lauryl sulfate to water (SDS; 0.065 g/mL water). Half of the Halar® MBF samples were dipped in the emulsion long enough for them to impregnate the emulsion into the pores, after which the samples were kept at 60° C. for 0-2 hours in an inert atmosphere. The Halar® 300LC samples and the other half of the Halar® MBF were immersed in the emulsion at 60° C. for 0-2 hours, in an inert atmosphere. The p-Me-TFS graft copolymer membranes were then washed twice with acetone and once with toluene before being dried at 45° C. in a vacuum (3.9 kPa) for 3 hours. The percentage graft polymerization for each sample was then determined as described in Example 1.

The reaction conditions and percentage graft polymerization for each sample is summarized in Table 2.

TABLE 2
Emulsion graft polymerization of p-Me-TFS to
poly(ethylene-co-chlorotrifluoroethylene) film

| | | % Graft | | |
|---|---|---|---|---|
| | Reaction | Dense Film | Porous Film | Porous Film |
| Sample | Time (h) | Immersed | Immersed | Dipped |
| 3 | 0.0 | 0.0 | 0.0 | 0.0 |
| 4 | 0.5 | 5.7 | 16 | 16 |
| 5 | 1.0 | 9.7 | 21 | 21 |
| 6 | 2.0 | 21 | 29 | 29 |

### EXAMPLE 3

### Sulfonation of Poly(Ethylene-Co-Tetrafluoroethylene)-G-p-ME-TFS

Two 7 cm×7 cm samples of poly(ethylene-co-chlorotrifluoroethylene) (Halar®) film were prepared as follows. Sample 7 was 25 μm thick Halar® 300LC (dense film) and Sample 8 was Halar® MBF (porous film; 630 μm thick, 204 g/m²).

Sample 7 was irradiated with a dose of 5 Mrad using a 10 MeV ion beam radiation source, in an inert atmosphere with dry ice cooling. The sample was then exposed to neat, degassed p-Me-TFS for 4 h at 60° C.

Sample 8 was irradiated with a dose of 10 Mrad under the same conditions. A 30% (v/v) emulsion was prepared by adding neat, degassedp-Me-TFS and sodium lauryl sulfate to water (SDS; 0.065 g/ml water). Sample 8 was dipped in the emulsion long enough for it to impregnate the emulsion into the pores, after which it was kept at 50-60° C. for 0-2 hours in an inert atmosphere. The Halar® 300LC samples and the other half of the Halar® MBF were immersed in the emulsion at 60° C. for 2 hours, in an inert atmosphere.

The p-Me-TFS graft copolymer membranes were then washed twice with acetone and once with toluene before being dried at 45° C. in a vacuum (3.9 kPa) for 3 hours. The percentage graft polymerization for each sample was then determined as described in Example 1.

Each sample was then immersed in a sulfonation solution (30% SO₃ (v/v) in dichloroethane) for 0.5 hr at 50° C. The EW of the sulfonated samples was determined, as was the amount of water present in the samples. From this data the percentage sulfonation of the samples was determined. Percentage sulfonation is measured as the percentage of available sites on the graft copolymer that are sulfonated, assuming one sulfonate group per monomer repeat unit. The sulfonation results are summarized in Table 3.

TABLE 3
Sulfonation of poly(ethylene-
co-tetrafluoroethylene)-g-p-Me-TFS

| Sample | % Graft | % Sulfonation |
|---|---|---|
| 7 | 30 | 95 |
| 8 | 29 | 102 |

The present process provides for the preparation of graft copolymer membranes from fluorostyrenic monomers that is straightforward and makes efficient use of the monomers. Compared to dense films, a porous polymeric film has an increased surface area that allows for increased grafting rates. Due to its porosity, the interior of a porous polymeric film can be homogeneously contacted with monomers prior to initiation of grafting, which may result in a more homogeneous distribution of graft polymer chains through the volume of the base film. And as demonstrated, a porous film can increase sulfonation rates relative to a dense film, and may also lead to a more homogeneous distribution of ion exchange groups in the final membrane.

As demonstrated, when a porous polymeric base film is dipped into monomer, sufficient monomer can be impregnated to achieve acceptable levels of graft polymerization. Therefore, the base film does not need to be immersed in or otherwise contacted with the monomer throughout the grafting process. This can provide significant cost savings since the amount of monomer required to support the desired level of grafting is reduced. Further, the present process allows for a separation of the steps of contacting the base film with monomer and inducing graft polymerization. This then allows for storage of the monomer at a lower temperature to minimize side reactions, while the temperature of the grafting reaction can be selected for increased grafting rates. For example, the monomers may be at room temperature or colder when impregnated into the base film. The impregnated base film may then be heated to 50° C. or more; higher grafting temperatures, and hence higher grafting rates, may be possible while reducing the effect of undesirable side reactions.

As demonstrated above, the grafting rates and/or efficient use of monomer can be further increased by the use of monomer emulsions in the present process.

In addition, a porous polymeric base film experiences reduced or no expansion in the x-y dimension during graft polymerization, due to its void space. In a continuous process, this can be a significant advantage, since the porous material may require less sophisticated tension control systems and make it easier to process than dense films which do experience dimensional change during graft polymerization.

Further, with dense films it can be difficult to introduce additives into the polymeric matrix after the film has been extruded. Using a porous polymeric base film enables additives to be incorporated at a later stage of membrane manufacture by trapping them during the process of densifying.

Where the graft copolymer membrane is intended for use as an ion exchange membrane in an electrochemical cell, such as a fuel cell, for example, the membrane may be densified by collapsing the porosity during bonding with electrodes to form an MEA. In this manner, it is expected that the electrocatalyst may flow into the pores of the membrane during bonding and enhance the interfacial area of contact. This in turn may increase cell performance and/or result in a more robust MEA that is less prone to delamination.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

What is claimed is:

1. A process for preparing a substantially gas-impermeable graft copolymer membrane, the process comprising:
(a) exposing a porous polymeric base film to a dose of ionizing radiation in an inert atmosphere;
(b) contacting the irradiated base film with at least one fluorostyrenic monomer to form a graft copolymer membrane; and
(c) then densifying the graft copolymer membrane.

2. The process of claim 1 wherein the base film comprises a fluorinated polymer.

3. The process of claim 1 wherein the base film comprises a polymer selected from the group consisting of polyvinylidene fluoride, poly(tetrafluoroethylene-co-perfluorovinylether), poly(tetrafluoroethylene-co-hexafluoropropylene), poly(ethylene-co-chlorotrifluoroethylene), polyethylene, polypropylene, poly(ethylene-co-tetrafluoroethylene), poly(vinylidene fluoride-co-hexafluoropropylene), poly(vinylidene fluoride-co-chlorotrifluoroethylene), and polytetrafluoroethylene.

4. The process of claim 1 wherein the base film comprises polyvinylidene fluoride.

5. The process of claim 1 wherein the base film comprises poly(ethylene-co-chlorotrifluoroethylene).

6. The process of claim 1 wherein the base film comprises ultra-high molecular weight polyethylene.

7. The process of claim 1 wherein the dose of ionizing radiation is in the range of about 1 Mrad to about 100 Mrad.

8. The process of claim 1 wherein the dose of ionizing radiation is in the range of about 20 Mrad to about 60 Mrad.

9. The process of claim 1 wherein the at least one fluorostyrenic monomer is selected from the group consisting of substituted and unsubstituted α-fluorostyrenes, α,β-difluorostyrenes, and α,β,β-trifluorostyrenes, and mixtures thereof.

10. The process of claim 1 wherein the at least one fluorostyrenic monomer comprises a substituted α,β,β-trifluorostyrene.

11. The process of claim 10 wherein the at least one fluorostyrenic monomer is selected from the group consisting of methyl-α,β,β-trifluorostyrenes, methoxy-α,β,β-trifluorostyrenes, thiomethyl-α,β,β-trifluorostyrenes, phenyl-α,β,β-trifluorostyrenes, and mixtures thereof.

12. The process of claim 1 wherein the at least one fluorostyrenic monomer comprises para-methyl-α,β,β-trifluorostyrene.

13. The process of claim 1 wherein the irradiated base film is contacted with a mixture comprising at least one fluorostyrenic monomer and at least one monomer selected from the group consisting of styrene, α-methylstyrene, and vinyl phosphonic acid.

14. The process of claim 1 wherein the irradiated base film is contacted with a solution comprising the at least one fluorostyrenic monomer.

15. The process of claim 1 wherein the irradiated base film is contacted with an emulsion comprising the at least one fluorostyrenic monomer.

16. The process of claim 15 wherein the emulsion is an aqueous emulsion.

17. The process of claim 1 wherein the irradiated base film is contacted with the at least one fluorostyrenic monomer at a temperature of about 20° C. to about 100° C.

18. The process of claim 1 wherein the irradiated base film is contacted with the at least one fluorostyrenic monomer at a temperature of about 50° C. to about 80° C.

19. The process of claim 1 wherein the irradiated base film is immersed in the at least one fluorostyrenic monomer.

20. The process of claim 1 wherein the irradiated base film is sprayed with the at least one fluorostyrenic monomer.

21. The process of claim 1 wherein the graft copolymer membrane is densified by collapsing its porosity.

22. The process of claim 21 wherein the porosity is collapsed by applying heat and pressure to the graft copolymer membrane.

23. The process of claim 22 wherein the graft copolymer membrane is heated to at least the melt flow temperature of the base film.

24. The process of claim 1, further comprising introducing ion exchange functionality into the graft copolymer membrane.

25. The process of claim 1, further comprising treating the graft copolymer membrane by a reaction selected from the group consisting of halomethylation, sulfonation, phosphonation, amination, carboxylation, hydroxylation and nitration.

26. The process of claim 1, further comprising sulfonating or phosphonating the graft copolymer membrane.

27. The process of claim 1, further comprising sulfonating the graft copolymer membrane.

28. The process of claim 27 wherein the step of sulfonating the graft copolymer membrane precedes the densifying step.

29. The process of claim 27, further comprising converting at least a portion of sulfonate groups in the graft copolymer membrane to sulfonate salts before the densifying step.

30. The process of 27 wherein the graft copolymer membrane is sulfonated by swelling the graft copolymer membrane in a halogenated solvent and exposing it to sulfur trioxide vapour.

31. The process of claim 27 wherein the graft copolymer membrane is sulfonated by exposing it to chlorosulfonic acid, introducing a sulfonyl halide functionality into the graft copolymer membrane, and hydrolyzing the sulfonyl halide functionality.

32. The process of claim 31 wherein the step of introducing the sulfonyl halide functionality into the graft copolymer membrane occurs before the densifying step, and the step of hydrolyzing the sulfonyl halide functionality occurs after the densifying step.

33. The process of claim 1, further comprising introducing an additive into the porosity of the graft copolymer membrane.

34. The process of claim 33 wherein the additive comprises a hygroscopic compound.

35. The process of claim 34 wherein the hygroscopic compound is selected from the group consisting of hydrogels, dicarboxylic acids, anhydrides and silicates.

36. The process of claim 33 wherein the additive comprises an inorganic proton conductor.

37. The process of claim 36 wherein the inorganic proton conductor is selected from the group consisting of zirconium phosphate, cerium phosphate, aluminum phosphate-based zeolites, and polyantimonic acid.

38. A process for preparing a graft copolymer membrane, the process comprising:
(a) exposing a porous polymeric base film to a dose of ionizing radiation in an inert atmosphere; and
(b) contacting the irradiated base film with an emulsion comprising at least one fluorostyrenic monomer, wherein the amount of monomer in the emulsion is less than or equal to 30% by volume.

39. The process of claim 38 wherein the base film comprises a polymer selected from the group consisting of polyvinylidene fluoride, poly(tetrafluoroethylene-co-perfluorovinylether), poly(tetrafluoroethylene-co-hexafluoropropylene), poly(ethylene-co-chlorotrifluoroethylene), polyethylene, polypropylene, poly(ethylene-co-tetrafluoroethylene), poly(vinylidene fluoride-co-hexafluoropropylene), poly(vinylidene fluoride-co-chlorotrifluoroethylene), and polytetrafluoroethylene.

40. The process of claim 38 wherein the base film comprises a polymer selected from the group consisting of polyvinylidene fluoride poly(ethylene-co-chlorotrifluoroethylene), and ultra-high molecular weight polyethylene.

41. The process of claim 38 wherein the dose of ionizing radiation is in the range of about 1 Mrad to about 100 Mrad.

42. The process of claim 38 wherein the dose of ionizing radiation is in the range of about 20 Mrad to about 60 Mrad.

43. The process of claim 38 wherein the emulsion is an aqueous emulsion.

44. The process of claim 38 wherein the emulsion further comprises a solvent that aids in swelling of the base film.

45. The process of claim 38 wherein the emulsion further comprises an emulsifier.

46. The process of claim 45 wherein the emulsifier comprises dodecylamine hydrochloride or sodium lauryl sulfate.

47. The process of claim 38 wherein the emulsion further comprises an inhibitor.

48. The process of claim 38 wherein the at least one fluorostyrenic monomer comprises a substituted α,β,β-trifluorostyrene.

49. The process of claim 48 wherein the at least one fluorostyrenic monomer is selected from the group consisting of methyl-α,β,β-trifluorostyrenes, methoxy-α,β,β-trifluorostyrenes, thiomethyl-α,β,β-trifluorostyrenes, phenyl-α,ββ-trifluorostyrenes, and mixtures thereof.

50. The process of claim 38 wherein the at least one fluorostyrenic monomer comprises para-methyl-α,β, β-trifluorostyrene.

51. The process of claim 38 wherein the at least one fluorostyrenic monomer is selected from the group consisting of substituted and unsubstituted α-fluorostyrenes, α,β-difluorostyrenes, and α,β,β-trifluorostyrenes, and mixtures thereof.

52. The process of claim 38 wherein the emulsion further comprises at least one monomer selected from the group consisting of styrene, α-methylstyrene and vinyl phosphonic acid.

53. The process of claim 38 wherein the irradiated base film is contacted with the emulsion at a temperature of about 20° C. to about 100° C.

54. The process of claim 38 wherein the irradiated base film is contacted with the emulsion at a temperature of about 50° C. to about 80° C.

55. The process of claim 38 wherein the irradiated base film is immersed in the emulsion.

56. The process of claim 38 wherein the irradiated base film is sprayed with the emulsion.

57. The process of claim 38 wherein the amount of monomer in the emulsion is less than or equal to 10% by volume.

58. The process of claim 38, further comprising sulfonating or phosphonating the graft copolymer membrane.

59. The process of claim 38, further comprising sulfonating the graft copolymer membrane.

60. A process for preparing a substantially gas impermeable ion exchange membrane comprising collapsing the porosity of a porous ion exchange material.

61. The process of claim 60 wherein the porosity is collapsed by applying heat and pressure to the material.

62. A process for preparing a graft copolymer membrane, the process comprising:
(a) exposing a continuous web comprising a porous polymeric base film to a dose of ionizing radiation in an inert atmosphere;
(b) impregnating the irradiated base film with at least one fluorostyrenic monomer at a first temperature; and
(c) exposing the irradiated base film and impregnated monomer to a second temperature to form a graft copolymer, wherein the second temperature is greater than the first temperature.

63. The process of claim 62 wherein the base film comprises a polymer selected from the group consisting of polyvinylidene fluoride, poly(tetrafluoroethylene-co-perfluorovinylether), poly(tetrafluoroethylene-co-hexafluoropropylene), poly(ethylene-co-chlorotrifluoroethylene), polyethylene, polypropylene, poly(ethylene-co-tetrafluoroethylene), poly(vinylidene fluoride-co-hexafluoropropylene), poly(vinylidene fluoride-co-chlorotrifluoroethylene), and polytetrafluoroethylene.

64. The process of claim 62 wherein the base film comprises a polymer selected from the group consisting of polyvinylidene fluoride, poly(ethylene-co-chlorotrifluoroethylene), and ultra-high molecular weight polyethylene.

65. The process of claim 62 wherein the dose of ionizing radiation is in the range of about 1 Mrad to about 100 Mrad.

66. The process of claim 62 wherein the dose of ionizing radiation is in the range of about 20 Mrad to about 60 Mrad.

67. The process of claim 62 wherein the at least one fluorostyrenic monomer is selected from the group consisting of substituted and unsubstituted α-fluorostyrenes, α,β-difluorostyrenes, and α,β,β-trifluorostyrenes, and mixtures thereof.

68. The process of claim 62 wherein the at least one fluorostyrenic monomer comprises a substituted α,β,β-trifluorostyrene.

69. The process of claim 62 wherein the at least one fluorostyrenic monomer is selected from the group consisting of methyl-α,β,β-trifluorostyrenes, methoxy-α,β,β-trifluorostyrenes, thiomethyl-α,β,β-trifluorostyrenes, phenyl-α,β,β-trifluorostyrenes, and mixtures thereof.

70. The process of claim 62 wherein the at least one fluorostyrenic monomer comprises para-methyl-α,β,β-trifluorostyrene.

71. The process of claim 62 wherein the irradiated base film is impregnated with a mixture comprising at least one fluorostyrenic monomer and at least one monomer selected from the group consisting of styrene, α-methylstyrene, and vinyl phosphonic acid.

72. The process of claim 62 wherein the irradiated base film is impregnated with a solution comprising the at least one fluorostyrenic monomer.

73. The process of claim 62 wherein the irradiated base film is impregnated with an emulsion comprising the at least one fluorostyrenic monomer.

74. The process of claim 62 wherein the first temperature is less than or equal to room temperature.

75. The process of claim 62 wherein the second temperature is at least about 50° C.

76. The process of claim 62 wherein the second temperature is about 50° C. to about 80° C.

77. The process of claim 62 wherein the irradiated base film is immersed in the at least one fluorostyrenic monomer.

78. The process of claim 62 wherein the irradiated base film is sprayed with the at least one fluorostyrenic monomer.

79. The process of claim 62, further comprising densifying the graft copolymer membrane to render it substantially gas-impermeable.

80. The process of claim 80 wherein densifying the graft copolymer membrane comprises applying heat and pressure thereto.

81. The process of claim 62, further comprising sulfonating or phosphonating the graft copolymer membrane.

82. A process for preparing a substantially gas-impermeable graft copolymer membrane, the process comprising:
(a) exposing a porous polymeric base film to a dose of ionizing radiation;
(b) contacting the irradiated base film with at least one fluoronaphthyl monomer to form a graft copolymer membrane; and
(c) then densifying the graft copolymer membrane.
